(19) United States
(12) Patent Application Publication
(10) Pub. No.: US 2021/0132728 A1
(43) Pub. Date: May 6, 2021

(54) ELECTRONIC DEVICE INCLUDING SENSOR FOR DETECTING EXTERNAL INPUT

(71) Applicant: Samsung Electronics Co., Ltd., Gyeonggi-do (KR)

(72) Inventors: Yongho HWANG, Gyeonggi-do (KR); Sanghyeon KIM, Gyeonggi-do (KR); Soogyu LEE, Gyeonggi-do (KR); Minjong LIM, Gyeonggi-do (KR); Jinwan AN, Gyeonggi-do (KR); Jiwoo LEE, Gyeonggi-do (KR)

(21) Appl. No.: 17/091,174

(22) Filed: Nov. 6, 2020

(30) Foreign Application Priority Data
Nov. 6, 2019 (KR) 10-2019-0141086

(51) Int. Cl. G06F 3/041; G06F 1/16

(52) U.S. Cl. CPC G06F 3/0414; G06F 3/0416; G06F 1/1626

(57) ABSTRACT

The disclosure relates to an electronic device comprises a frame forming a side surface of the electronic device; at least one opening formed on a certain region of the side surface; a thermoplastic member positioned on a region of an inner surface of the frame structure adjacent to the opening to fill at least a portion of the opening; and a sensor attached to an inner surface of the thermoplastic member and electrically connected with a processor.

### CROSS-REFERENCE TO RELATED APPLICATION(S)

This application is based on and claims priority under 35 U.S.C. § 119 to Korean Patent Application No. 10-2019-0141086, filed on Nov. 6, 2019, in the Korean Intellectual Property Office, the disclosure of which is herein incorporated by reference in its entirety.

### BACKGROUND

### Field

Certain embodiments of the disclosure relate to an electronic device including a sensor for detecting an external input.

### Description of Related Art

Recent electronic devices mostly use a touch screen device capable of inputting and outputting simultaneously, as a data input means. The touch screen device may display a switch-like input button on a display screen, and may be used to input data corresponding to the input button when a user touches the displayed input button.

However, the electronic device may include a key provided on one side surface of the electronic device, in addition to the data input means provided in the software way as described above. By intuitively operating the key, a user may perform various functions, such as a power on/off function, a function of switching to a wakeup mode or a sleep mode, a volume control, a function of swiftly jumping back to a pre-set default page from a current page.

The key provided on one side surface of the housing of the electronic device is generally a physical key including a switch module.

The above information is presented as background information only to assist with an understanding of the disclosure. No determination has been made, and no assertion is made, as to whether any of the above might be applicable as prior art with regard to the disclosure.

### SUMMARY

According to certain embodiments, an electronic device comprises a frame forming a side surface of the electronic device; at least one opening formed on a certain region of the side surface; a thermoplastic member positioned on a region of an inner surface of the frame structure adjacent to the opening to fill at least a portion of the opening; and a sensor attached to an inner surface of the thermoplastic member and electrically connected with a processor.

According to certain embodiments, an electronic device comprises a frame forming a side surface of the electronic device; a thermoplastic member positioned on at least a certain region of an inner surface of the frame structure; and a sensor attached to an inner surface of the thermoplastic member and electrically connected with the processor.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to certain embodiments;

FIG. 2A is a perspective view illustrating an electronic device according to certain embodiments;

FIG. 2B is a perspective view of the electronic device of FIG. 2A seen from the rear surface;

FIG. 3 is an exploded perspective view of an electronic device according to certain embodiments;

FIG. 4A is a view illustrating an electric connection relationship of an electronic device according to an embodiment;

FIG. 4B is a cross-sectional perspective view of the electronic device of FIG. 4A, taken on line A-A′;

FIG. 5A is a front view illustrating a frame structure of an electronic device according to an embodiment;

FIG. 5B is a view illustrating an thermoplastic member and a sensor which are mounted on an inner surface of the frame structure according to an embodiment;

FIG. 5C is a view illustrating an thermoplastic member and a sensor which are mounted on an inner surface of the frame structure according to another embodiment;

FIG. 5D is a view illustrating an thermoplastic member and a sensor which are mounted on an inner surface of the frame structure according to still another embodiment;

FIG. 5E is a view illustrating an thermoplastic member, a sensor, and a light emitting diode (LED) module which are mounted on an inner surface of the frame structure according to an embodiment;

FIG. 6A is a view illustrating a state in which a user's touch input is inputted to an electronic device according to an embodiment;

FIG. 6B is a view illustrating a state in which a user's swipe input is inputted to the electronic device according to an embodiment;

FIG. 6C is a view illustrating a state in which a user's squeeze input is inputted to the electronic device according to an embodiment;

FIG. 7A is a view illustrating a key input device positioned on one side surface of an electronic device according to an embodiment;

FIG. 7B is a view illustrating a key input device positioned on one side surface of the electronic device according to another embodiment;

FIG. 8A is a perspective view illustrating an electronic device according to an embodiment;

FIG. 8B is a view illustrating an thermoplastic member and a sensor which are mounted in the electronic device of FIG. 8A;

FIG. 8C is a perspective view illustrating an electronic device according to another embodiment; and

FIG. 8D is a perspective view illustrating an electronic device according to still another embodiment.

### DETAILED DESCRIPTION

Replacing the physical key with a virtual key can provide a more aesthetically pleasing electronic device. The foregoing can be accomplished by attaching a force sensor to one side surface of the surface of the electronic device and detecting the user's input. However, it may be difficult for a user to intuitively recognize a position of the force sensor since there is no separate physical structure protruding from one side surface of the electronic device. Therefore, additional processing may be needed to display the position of the force sensor on the side surface of the electronic device.

Additionally, the measurement value sensed by the force sensor can be influenced by a change in temperature. For example, heat may be transmitted to the force sensor through a housing formed with a metallic material, thereby affecting the measurement value of the force sensor. Therefore, a process may be needed to compensate the measurement value according to temperature.

To overcome the above-described problems, the disclosure provides an electronic device which has an thermoplastic member penetrating through a side surface thereof and has a force sensor attached to an inner surface of the thermoplastic member. A change in temperature of the electronic device has less effect on the measurement value of the force sensor. Additionally, its position can be seen without separate additional processing.

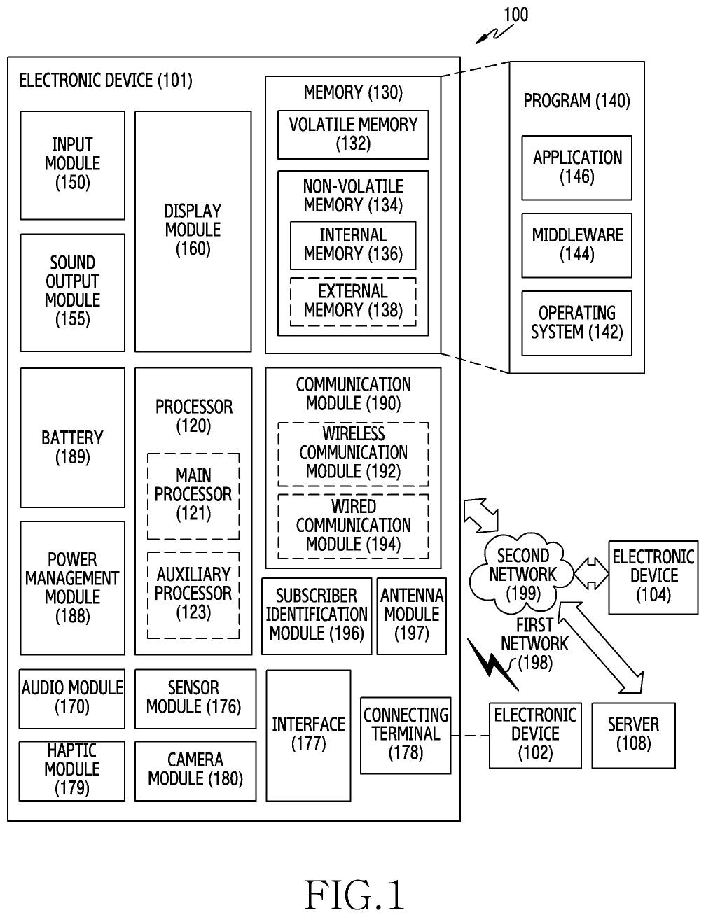

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen). The input device 150 can also include a physical key for, by example, turning off the device, and volume. However, physical keys detract from the aesthetic appearance of the electronic device.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. The sensor module 176 can also include a force sensor that can detect touching by the user.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images.

According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

Though not limited to such, electronic devices can include smartphones. Smartphones are generally planar with a very thin dimension orthogonal to the plane. Replacing the physical key with a virtual key can provide a more aesthetically pleasing electronic device. The foregoing can be accomplished by attaching a force sensor to one side surface of the surface of the electronic device and detecting the user's input. However, it may be difficult for a user to intuitively recognize a position of the force sensor since there is no separate physical structure protruding from one side surface of the electronic device. Therefore, additional processing may be needed to display the position of the force sensor on the side surface of the electronic device.

Additionally, the measurement value sensed by the force sensor can be influenced by a change in temperature. For example, heat may be transmitted to the force sensor through a housing formed with a metallic material, thereby affecting the measurement value of the force sensor. Therefore, a process may be needed to compensate the measurement value according to temperature.

To overcome the above-described problems, the disclosure provides an electronic device which has an thermoplastic member penetrating through a side surface thereof and has a force sensor attached to an inner surface of the thermoplastic member. A change in temperature of the electronic device has less effect on the measurement value of the force sensor. Additionally, its position can be seen without separate additional processing.

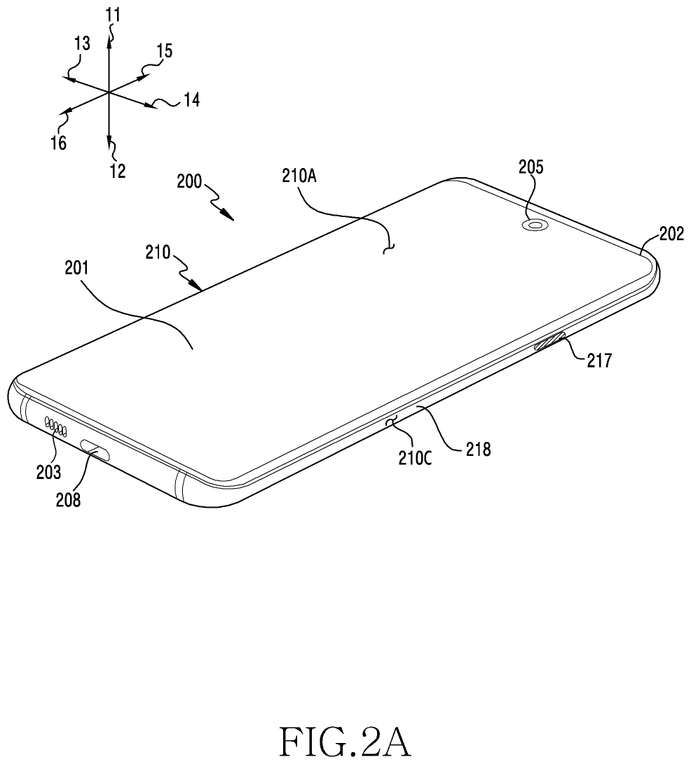

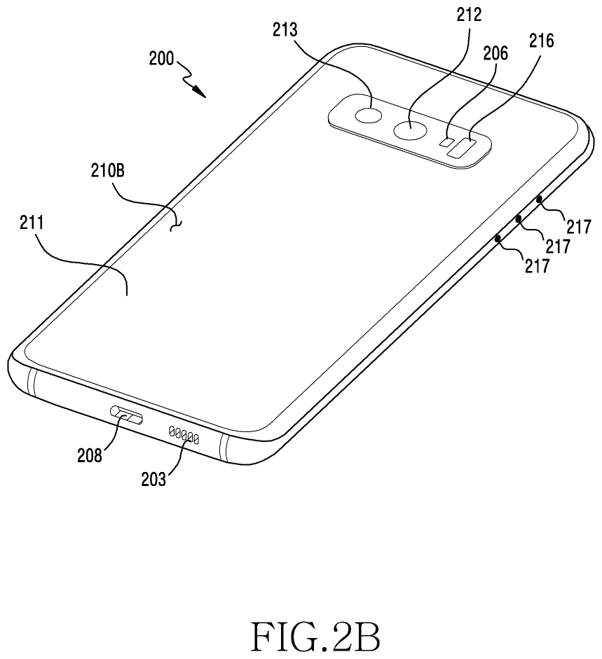

FIGS. 2A and 2B describe the housing of the electronic device with a key 217 in accordance with certain embodiments of the invention.

FIG. 2A is a perspective view illustrating an electronic device 200 according to certain embodiments. FIG. 2B is a perspective view of the electronic device 200 of FIG. 2A seen from the rear surface.

Referring to FIGS. 2A and 2B, the electronic device 200 (for example, the electronic device 101 of FIG. 1) according to certain embodiments may include a housing 210 which includes a first surface (or a front surface) 210A facing in a first direction 11, a second surface (or a rear surface) 210B facing in a second direction 12, which is the opposite direction of the first direction 11, and a side surface (or a side wall) 210C surrounding a space between the first surface 210A and the second surface 210B. In another embodiment (not shown), the housing 210 may refer to a structure that forms a portion of the first surface 210A, the second surface 210B, and the side surface 210C of FIGS. 2A and 2B.

The display module 160 is generally disposed on front surface 210A. While a large amount of inputs to the electronic device 200 are received by a virtual keyboard provided by the display module 160, it is noted that providing the virtual keyboard may require the device to be power up, and booted. Moreover, displaying the virtual keyboard may also require some triggering event. However, it may be advantageous to allow for input to the electronic device 200 that can be received without a virtual keyboard. While a physical key is possible, the same detracts from the sleek and smooth design of the electronic device. Accordingly, a key 217 abuts a connector hole 208. In that manner, the side surface 210C is smooth with no protrusions. Additionally, the use can easily locate the key 217 because of connector hole 208.

According to an embodiment, the first surface 210A may be formed by a front surface plate 202 (for example, a glass plate including various coating layers, or a polymer plate) at least a portion of which is substantially transparent. According to an embodiment, the front surface plate 202 may include a curved portion that is bent from the first surface 210A toward a rear surface plate 211 and is seamlessly extended.

According to an embodiment, the second surface 210B may be formed by the rear surface plate 211 which is substantially opaque. The rear surface plate 211 may be formed with, for example, coated or colored glass, ceramic, polymer, metal (for example, aluminum, stainless steel (STS), or magnesium), or a combination of at least two of the above-mentioned materials. According to an embodiment, the rear surface plate 211 may include a curved portion that is bent from the second surface 210B toward the rear surface plate 202 and is seamlessly extended.

According to an embodiment, the side surface 210C may be formed by a frame structure 210 coupled with the front surface plate 202 and the rear surface plate 211 and including metal, ceramic, and/or polymer. According to an embodiment, the rear surface plate 211 and the frame structure (or frame) 218 may be integrally formed with each other, and may include the same material (for example, a metallic material such as aluminum, ceramic, polymer, etc.).

The electronic device 200 according to certain embodiments may include at least one of a display 210, an audio module 203, a sensor module (not shown), a camera module 205, 206, 212, 213, a key input device 217, and a connector hole 208. According to a certain embodiment, the electronic device 200 may omit at least one (for example, the key input device 217) of the components or may additionally include other components.

According to an embodiment, the electronic device 200 may include the sensor module (for example, a proximity sensor, an illuminance sensor). For example, the sensor module may be disposed on a position adjacent to the display 201, and in another example, the sensor module may be mounted on a rear surface of the display 201 within a region provided by the front surface plate 202 to be integrated into the display 201.

The electronic device 200 according to an embodiment may further include a light emitting element, although it is not illustrated on the drawing, and the light emitting element may be disposed on a position adjacent to the display 201 within a region provided by the front surface plate 202. The light emitting element may provide state information of the electronic device 200 in the form of light, and according to another embodiment, the light emitting element may provide a light source which operates in association with the operation of the camera module. The light emitting element may include, for example, at least one of a light emitting diode (LED), an infrared LED (IR LED), and a xenon lamp.

According to certain embodiments, the display 201 may be seen from the outside of the electronic device 200 through a substantial portion of the front surface plate 202. In a certain embodiment, an edge of the display 201 may be formed substantially the same as a border shape (for example, a curved surface) of the front surface plate 202 that is adjacent to the display. In another embodiment (not shown), a gap between the border of the display 201 and the border of the front surface plate 202 may be formed substantially the same to extend a seen area of the display 201. In another embodiment, a recess or an opening may be formed on a portion of a screen display region of the display 201, and the electronic device 200 may include other electronic components aligned with the recess or the opening, for example, the camera module 205, a proximity sensor or an illuminance sensor. In another embodiment, at least one of the camera module 212, 213, a fingerprint sensor 216, and a flash 206 may be included on a back surface of the screen display region of the display 201. In another embodiment (not shown), the display 201 may be coupled with or disposed adjacent to a touch detection circuitry, a pressure sensor for measuring a strength (pressure) of a touch, and/or a digitizer for detecting a stylus pen of a magnetic field method.

According to an embodiment, the audio module may include a microphone hole and a speaker hole 203. The microphone hole may have a microphone disposed therein to acquire an external sound, and in a certain embodiment, the microphone hole may have a plurality of microphones disposed therein to detect a direction of a sound. In a certain embodiment, the speaker hole 203 and the microphone hole may be implemented as one hole, or a speaker (for example, a piezo speaker) may only be included without a separate speaker hole.

The electronic device 200 may include the sensor module (not shown), thereby generating an electric signal or a data value corresponding to an internal operation state or an external environment state. According to an embodiment, the sensor module may further include a fingerprint sensor integrated into or disposed adjacent to the display 201, and/or a biometric sensor (for example, a heart rate monitor (HRM) sensor) disposed on the second surface 210B of the housing 210. According to another embodiment, the electronic device 200 may further include the sensor module (not shown), for example, at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

According to an embodiment, the camera module 205, 206, 212, 213 may include a first camera device 205 disposed on the first surface 210A of the electronic device 200, a second camera device 212, 213 disposed on the second surface 210B, and/or the flash 206. The camera devices 205, 212, 213 may include one lens or a plurality of lenses, an image sensor, and/or an image signal processor. The flash 206 may include, for example, a light emitting diode or a xenon lamp. In a certain embodiment, two or more lenses (an infrared camera, a wide angle lens and a telephoto lens) and image sensors may be disposed on one surface of the electronic device 200.

According to an embodiment, the key input device 217 may be disposed on the side surface 210C of the housing 210. For example, the key input device 217 may be formed in the form of a virtual key, and the electronic device 200 may detect a user input based on a degree of deformation of the housing 210 caused by a user's input on the key input device 217. This will be described in detail. The key input device 217 according to another embodiment (not shown) may be formed in the form of a physical key, and the electronic device 200 may detect a user's input on the key input device 217.

The electronic device 200 according to another embodiment may not include a portion or an entirety of the above-mentioned key input device 217, and the key input device 217 that is not included may be implemented on the display 201 in other forms such as a soft key. In a certain embodiment, the key input device 217 may include at least a portion of the fingerprint sensor 216 disposed on the second surface 210B of the housing 210.

According to an embodiment, the connector hole 208 may include a first connector hole to accommodate a connector (for example, a USB connector) for exchanging power and/or data with an external electronic device, and/or a second connector hole (for example, an earphone jack) to accommodate a connector for exchanging an audio signal with an external electronic device. In a certain embodiment, the first connector hole and the second connector hole may be implemented as a single hole 208, and in a certain embodiment, the electronic device 200 may exchange power and/or data with an external electronic device, or may exchange an audio signal, without a connector hole.

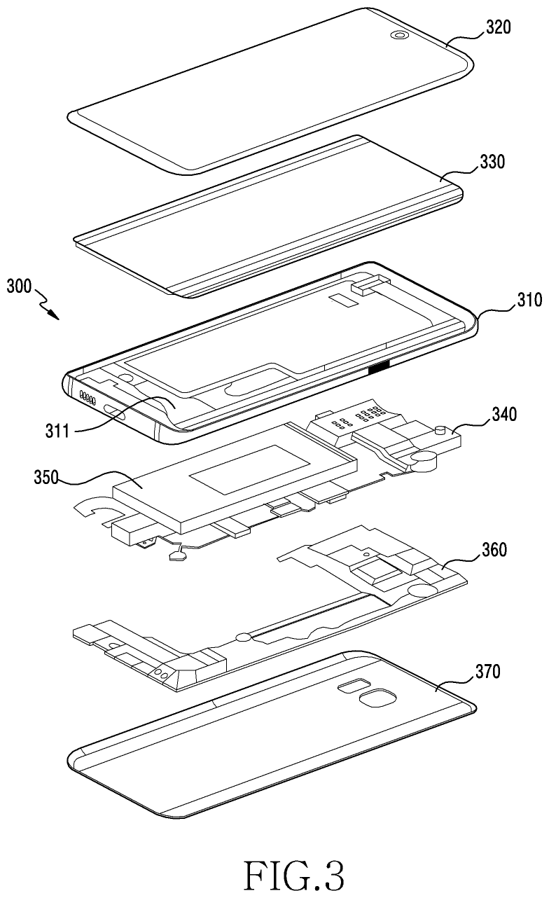

FIG. 3 is an exploded perspective view of an electronic device 300 according to certain embodiments.

Referring to FIG. 3, the electronic device 300 (for example, the electronic device 101 of FIG. 1 or the electronic device 200 of FIG. 2) may include a housing 310 (for example, the housing 210 of FIGS. 2A, 2B), a first support member 311 (for example, the frame structure 218 of FIGS. 2A, 2B), a front surface plate 320 (for example, the front surface plate 202 of FIGS. 2A, 2B), a display 330, a printed circuit board 340, a battery 350, a second support member 360 (for example, a rear case), and a rear surface plate 370 (for example, the rear surface plate 211 of FIGS. 2A, 2B).

In a certain embodiment, the electronic device 300 may omit at least one (for example, the second support member 360) of the components, or may additionally include other components. At least one of the components of the electronic device 300 may be the same as or similar to at least one of the components of FIGS. 2A, 2B, and a redundant explanation thereof is omitted.

According to an embodiment, the housing 310 may include a first surface (for example, the front surface 210A of FIG. 2A) of the electronic device 300, a second surface (for example, the rear surface 210B of FIG. 2B), and a side surface (for example, the side surface 210C of FIG. 2B) extended along borders of the first surface and the second surface and surrounding an inner space of the electronic device 300.

According to an embodiment, the first support member 311 may be disposed inside the electronic device 300 to be connected to the side surface of the housing 310, or may be integrally formed with the side surface of the housing 310. For example, the first support member 311 may be formed with a metallic material and/or a nonmetallic material (for example, polymer, ceramic). According to an embodiment, the display 330 may be coupled to one surface of the first support member 311, and the printed circuit board 340 may be coupled to the other surface.

According to an embodiment, the front surface plate 320 may form the first surface of the electronic device 300. The border of the front surface plate 320 may be connected to a portion of the side surface (or sidewall) of the housing 310 in contact therewith. The front surface plate 320 may be formed with a transparent polymer material such as polycarbonate (PC), polymethylmethacrylate (PMMA), polyimide (PE), polyethylene terephthalate (PET), polypropylene terephthalate (PPT), or a glass material. In this case, the transparent polymer or glass material may be merely an example of a material forming the front surface plate 320, and the material of the front surface plate 320 is not limited thereto.

According to an embodiment, the display 330 may include a plurality of layers, and may be disposed between the front surface plate 320 and the first support member 311. For example, the display 330 may include a base substrate, a thin film transistor (TFT) layer, an electrode layer, an organic material layer, or a pixel layer. According to an embodiment, the display 330 may further include certain appropriate components such as a thin film encapsulation layer for encapsulating a pixel layer, a back film to support the base substrate. The display 330 may emit light from pixels to deliver information to a user, and the emitted light may be delivered to the outside of the electronic device 300 through the front surface plate 320.

The display 330 may include a display panel (not shown) or a touch panel (not shown), and the touch panel may be disposed on a cell of the display panel. According to certain embodiments, the display 330 may be coupled with or disposed adjacent to some of a touch detection circuitry connected with the touch panel to detect a touch, a pressure sensor for measuring a strength (pressure) of a touch, or a digitizer for detecting a stylus pen in a magnetic field method.

According to an embodiment, the printed circuit board 340 may have a processor (for example, the processor 120 of FIG. 1), a memory, and/or an interface mounted thereon. For example, the processor may include one or more of a central processing device, an application processor, a graphic processing device, an image signal processor, a sensor hub processor, or a communication processor. The memory may include a volatile memory or a nonvolatile memory. The interface may include a high definition multimedia interface (HDMI), a universal serial bus (USB) interface, an SD card interface, and/or an audio interface. According to an embodiment, the interface may electrically or physically connect the electronic device 300 to an external electronic device, and may include a USB connector, an SD card/MMC connector, or an audio connector.

According to an embodiment, the battery 350 is a device that supplies power to at least one component of the electronic device 300, and may include a primary battery which cannot be recharged, or a secondary battery which is rechargeable, or a fuel cell. For example, the printed circuit board 340 may have an opening formed thereon, such that at least some regions of the battery 350 are disposed substantially on the same plane as the printed circuit board 340. According to an embodiment, the battery 350 may be integrally disposed inside the electronic device 300, or may be attachably and detachably disposed on the electronic device 300.

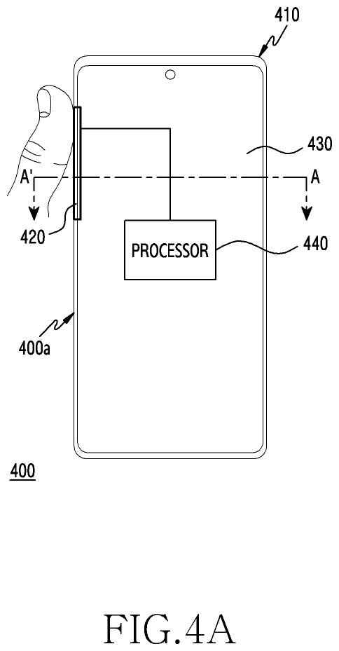

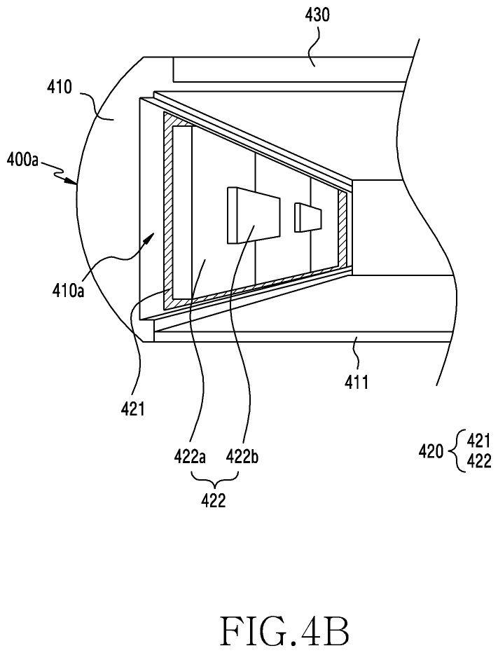

FIG. 4A is a view illustrating an electric connection relationship of an electronic device 400 according to an embodiment. FIG. 4B is a cross-sectional view of the electronic device 400 of FI. 4A, taken on line A-A′.

The key input device 420 may include a deformable thermoplastic member 421 with a sensor 422 configured to detect a degree of deformation of the thermoplastic member 421. The thermoplastic member 421 may obstruct a recess portion 410a of the frame structure 410 so as to be visible and exposed from the outside. A user touch deforms the thermoplastic member 421, which is detected by the sensor 422, which outputs a signal to the processor 440.

Referring to FIGS. 4A and 4B, the electronic device 400 according to certain embodiments may include a frame 410 (for example, the frame structure 218 of FIGS. 2A, 2B), a rear surface plate 411 (for example, the rear surface plate 211 of FIG. 2B), a key input device 420 (for example, the key input device 217 of FIGS. 2A, 2B), a display 430 (for example, the display 201 of FIGS. 2A, 2B), a processor 440 (for example, the processor 120 of FIG. 1). At least one of the components of the electronic device 400 may be the same as or similar to at least one of the components of the electronic device 200 of FIGS. 2A, 2B, or the electronic device 300 of FIG. 3, and a redundant explanation thereof is omitted.

The key input device 420 may be disposed on at least one side surface of the frame structure 410 forming a side surface 400a of the electronic device 400. The key input device 420 according to an embodiment (for example, see FIG. 4B) may include an thermoplastic member 421 and a sensor 422 attached to a certain region of the thermoplastic member 421. The thermoplastic member 421 can be formed by injection molding.

The thermoplastic member 421 may penetrate through a recess portion 410a formed on one side surface of the frame structure 410, and according to an embodiment, at least some regions of the thermoplastic member 421 may be seen from the outside of the frame structure 410. The thermoplastic member 421 may include polycarbonate (PC) material, for example, but is not limited thereto.

The sensor 422 may be attached to an inner surface of the thermoplastic member 421. When a user input (for example, a touch) is applied to the region of the thermoplastic member 421 that exposed to the outside of the frame structure 410, the thermoplastic member 421 deforms. The sensor 422 may measure a degree of deformation of the thermoplastic member 421. To more accurately measure the degree of deformation of the thermoplastic member 421, the inner surface region of the thermoplastic member 421 to which the sensor 422 is attached may be in a flat plate shape, which will be described in detail below.

In an embodiment (for example, see FIG. 4B), the sensor 422 may be a strain gauge including a flexible printed circuit board (FPCB) 422a and a variable resistor 422b. However, the type of the sensor 422 is not limited to the above-described embodiment, and in another embodiment, the sensor 422 may be a pressure sensor to detect a pressure applied to the thermoplastic member 421. The disclosure illustrates that the sensor 422 is a strain gauge, but the sensor 422 may be substituted with a pressure sensor or a force sensor for detecting a deformation of the thermoplastic member 421.

In the electronic device 400 according to an embodiment, the sensor 422 is attached to the inner surface of the thermoplastic member 421 penetrating through one side surface of the frame structure 410, rather than being directly attached to an inner surface of the frame structure 410, so that influence of heat transmitted through the frame structure 410 on measurement of the degree of deformation of the sensor 422 can be reduced. As a result, the electronic device 400 can enhance a detection rate of a user input without a process of compensating for a measurement value of the sensor 422 according to a change in temperature of the electronic device 400.

The sensor 422 of the key input device 420 according to an embodiment may be electrically connected with the processor 440 mounted in the electronic device 400. The processor 440 may detect whether a user input is inputted to the thermoplastic member 421, based on the degree of deformation of the thermoplastic member 421 measured by the sensor 422.

The processor 440 may identify a region of the thermoplastic member 421 to which the user input is inputted, and may control the electronic device 400 to perform different functions, based on the region to which the user input is inputted. For example, when a user input on a certain region of the thermoplastic member 421 is detected, the processor 440 may adjust the volume of the electronic device 400, and, when a user input on another region of the thermoplastic member 421 different from the certain region is detected, the processor 440 may turn on/off power. In another example, when a user input on a certain region of the thermoplastic member 421 is detected, the processor 440 may execute a voice assistance function.

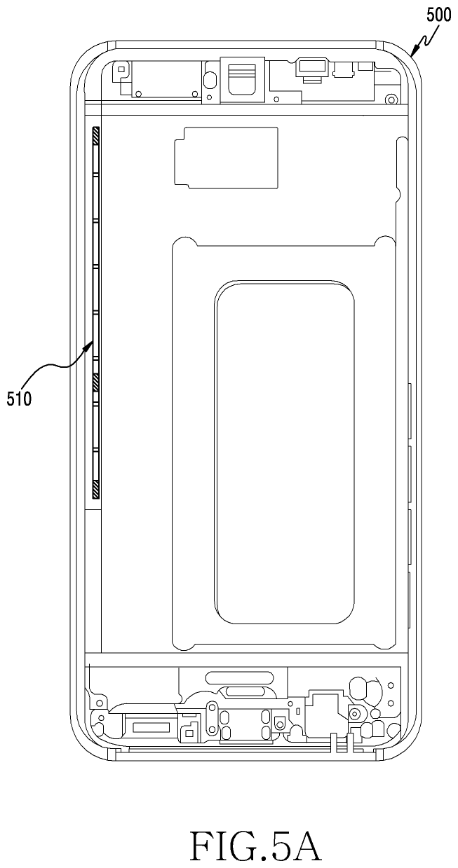

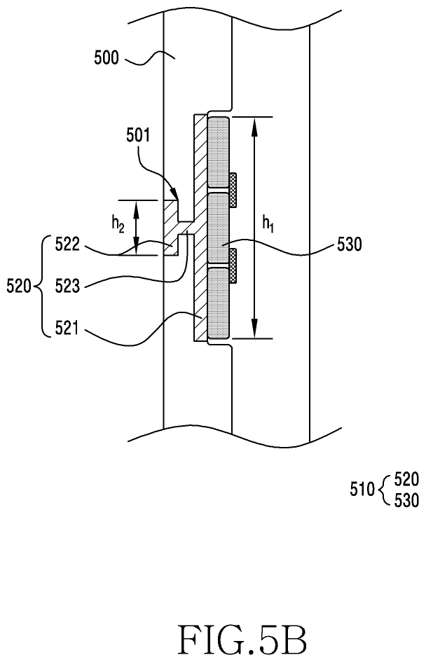

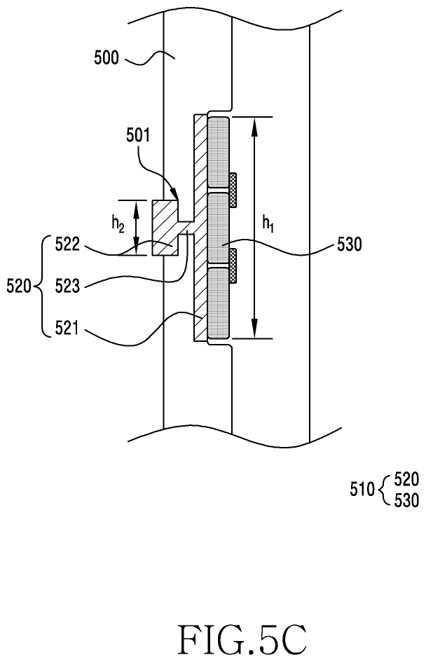

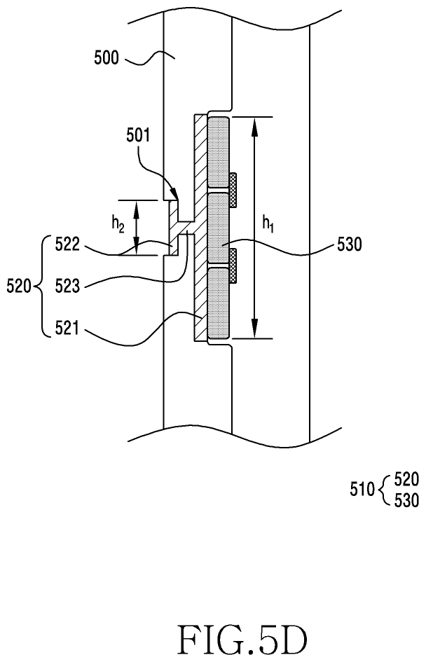

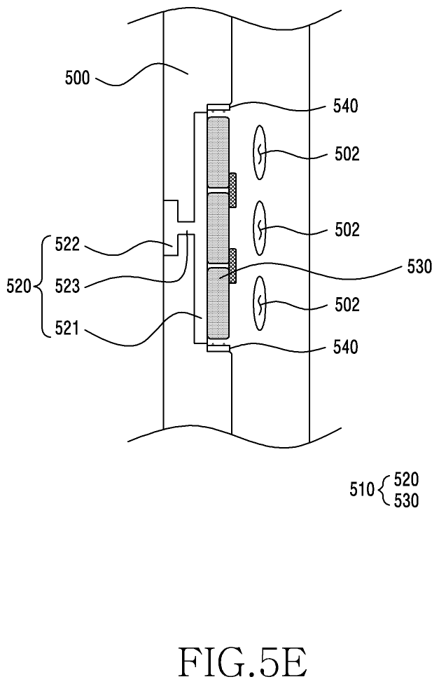

FIG. 5A is a front view illustrating a frame structure 500 of an electronic device according to an embodiment, and FIG. 5B is a view illustrating an thermoplastic member 520 and a sensor 530 which are mounted on an inner surface of the frame structure 500 according to an embodiment, FIG. 5C is a view illustrating an thermoplastic member 520 and a sensor 530 which are mounted on an inner surface of the frame structure 500 according to an embodiment, FIG. 5D is a view illustrating an thermoplastic member 520 and a sensor 530 which are mounted on an inner surface of the frame structure 500 according to an embodiment, and FIG. 5E is a view illustrating an thermoplastic member 520 and a sensor 530 which are mounted on an inner surface of the frame structure 500 according to an embodiment.

Referring to FIGS. 5A and 5B, the frame structure 500 (for example, the frame structure 410 of FIGS. 4A, 4B) of the electronic device (for example, the electronic device 400 of FIGS. 4A, 4B) according to certain embodiments may include at least one opening 501 formed on one side surface thereof to penetrate through the one side surface, and a key input device 510 may be disposed on a region adjacent to the opening 501. The key input device 510 may include the thermoplastic member 520 (for example, the thermoplastic member 421 of FIG. 4B) and the sensor 530 (for example, the sensor 422 of FIG. 4B). At least a portion of the components of the electronic device may be the same as or similar to at least one of the components of the electronic device 400 of FIGS. 4A and 4B, and a redundant explanation thereof is omitted.

The thermoplastic member 520 according to an embodiment may be formed by being insert-injected into the opening 501 of the frame structure 500, filling at least a portion of the opening 501. The thermoplastic member 520 may be exposed to the outside of the frame structure 500 through the opening 501, and the user may control the electronic device by touching or swiping on the portion of the thermoplastic member 520 that exposed through the opening 501.

In an embodiment, the thermoplastic member 520 may include an inner portion 521 positioned on an inner surface of the frame structure 500, an outer portion 522, and a connection portion 523 connecting the inner portion 521 and the outer portion 522.

The sensor 530 may be attached to the inner portion 521. In an embodiment, the inner portion 521 may be formed in a plate shape to guarantee a flatness of a region where the sensor 530 is attached, and as a result, can enhance accuracy of a measurement value of the sensor 530.

The outer portion 522 may be substantially parallel (or within 3 degrees of parallel) to the inner portion 521, and may fill at least some regions of the opening 501 of the frame structure 500. The outer portion 522 may be seen from the outside of the frame structure 500 through the opening 501. The position of the key input device 510 through the outer portion 522 conspicuously seen from the outside of the frame structure 500, thus allowing the user to readily ascertain its location. In an embodiment, h2 of the outer portion 522 may shorter than a h1 of the inner portion 521, but this should not be considered as limiting. In another embodiment, which will be described below, the height h2 of the outer portion 522 and the height h1 of the inner portion 521 may be substantially equal (or within 5% deviation).

In an embodiment (for example, see FIG. 5B), the outer portion 522 may completely fill the opening 501, and the key input device 510 does not protrude from the side surface of the frame structure 500 due to the shape of the outer portion 522 described above. The electronic device according to an embodiment does not have a visible protrusion (or detectable by the human finger) from the side surface of the key input device 510 due to the above-described structure, thereby improving the aesthetics of the electronic device.

In another embodiment (for example, see FIG. 5C), the outer portion 522 may completely fill the opening 501, while having a portion protruding to the outside of the frame structure 500. That is, the outer portion 522 may be formed on the side surface of the frame structure 500 in an embossed shape, and the user can intuitively the position of the key input device 510 through the above-described structure. However, the shape of the outer portion 522 is not limited to the above-described embodiment, and in another embodiment (for example, see FIG. 5D), the outer portion 522 may be formed in an engraved shape to fill only a portion of the opening 501.

In an embodiment, the thermoplastic member 520 may be formed with a material having lower rigidity than the frame structure 500. The thermoplastic member 520 may be formed with the material having lower rigidity than the frame structure 500, such that the thermoplastic member 520 is more deformed or bent than the frame structure 500 in response to the same user input. Accordingly, since the sensor 530 attached to the inner portion 521 detects the degree of deformation more than when the sensor 530 is directly attached to the inner surface of the frame structure 500, the electronic device 500 can further enhance a detection rate of a user input.

In one embodiment, the thermoplastic member 520 can be transparent and a LED module 540 can be disposed proximate to the thermoplastic member 520. The light from the LED module 540 adds to the aesthetic appearance and more conspicuously shows the location of the thermoplastic member 520. In an embodiment (for example, see FIG. 5E), the thermoplastic member 520 may be formed with a transparent material. The thermoplastic member 520 may be formed with, for example, a transparent polycarbonate (PC) material, but is not limited thereto. At least one LED module 540 may be disposed on a region adjacent to the sensor 530 attached to the inner surface of the thermoplastic member 520, and light emitting from the LED module 540 may be seen from the outside of the frame structure 500 through the transparent thermoplastic member 520. The LED module 540 may be electrically connected with a processor (for example, the processor 440 of FIG. 4A) mounted inside the electronic device, and the processor may control the operation of the LED module 540. The electronic device according to an embodiment may form various colors of the key input device 510 through the thermoplastic member 520 formed with the transparent material, and the LED module 540, and as a result, the aesthetic aspect of the electronic device can be enhanced.

In certain embodiments, the processor 440 controls the LED module 540 and cause the LED module 540 to form a particular color based on different conditions. For example, the LED module 540 can be red to indicate that the battery is low, and green to indicate that the battery is close to full charge.

According to an embodiment, the frame structure 500 may further include at least one slit 502 formed on a certain region of the frame structure 500 adjacent to the sensor 530. The at least one slit 502 may be formed on a region adjacent to a rear surface plate (for example, the rear surface plate 411 of FIG. 4B), for example. The at least one slit 502 may be disposed on a region adjacent to the sensor 530 at regular or irregular intervals, and the sensor 530 may be disposed between the thermoplastic member 520 and the at least one slit 502. According to an embodiment, the degree of permissible deformation of the thermoplastic member 520 causes the thermoplastic member 520 to go through the slit 502.

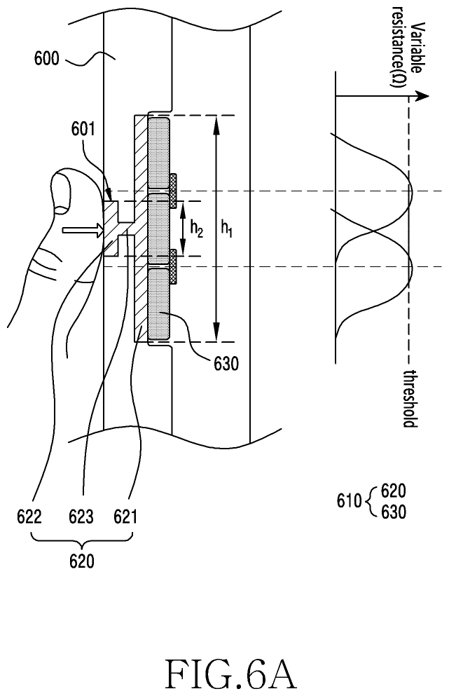

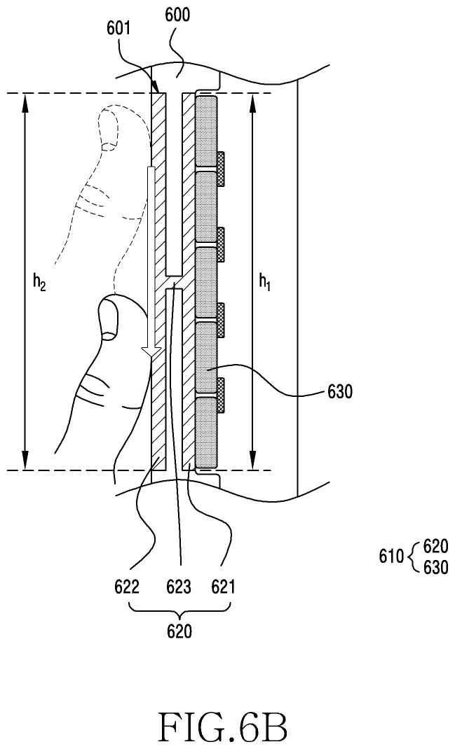

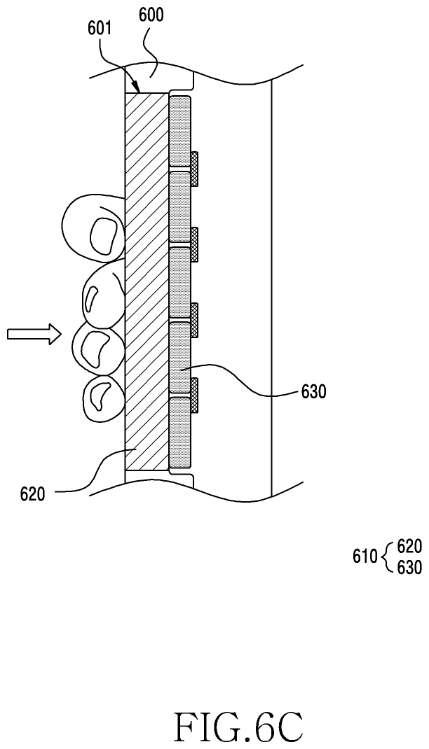

FIG. 6A is a view illustrating a state in which a user's touch input is inputted to an electronic device according to an embodiment. FIG. 6B is a view illustrate a state in which a user's swipe input is inputted to the electronic device according to an embodiment. FIG. 6C is a view illustrating a state in which a user's squeeze input is inputted to the electronic device according to an embodiment.

Referring to FIGS. 6A, 6B, 6C, the electronic device (for example, the electronic device 400 of FIGS. 4A, 4B) according to an embodiment may include a frame structure 600, and a key input device 610 including an thermoplastic member 620 and/or a sensor 630, and may detect a user's input on the key input device 610. At least one of the components of the electronic device may be the same as or similar to the components of the electronic device 400 of FIGS. 4A, 4B and/or the electronic device of FIGS. 5A, 5B, 5C, 5D, 5E, and a redundant explanation thereof is omitted.

The user input can include a press, a swipe, or a grip. The key input device 610 can include a thermoplastic member 620 with sensors 630. When a user input causes the thermoplastic member 620 to deform (for example, deform inwards), the sensor 630 corresponding to the location of the thermoplastic member that is touched detects the deformation. A user touch input can be considered to occur when one or two sensors 630 detect deformity at the same time. A user swipe input is considered to occur when each of the sensors 630 detects a deformity in successive time intervals. A user squeeze is considered to occur when each of the sensors 630 detect deformity at the same time.

The thermoplastic member 620 according to an embodiment may penetrate through at least one opening 601 formed on one side surface of the frame structure 600, and may be disposed on one side surface of the frame structure 600.

In an embodiment (for example, see FIGS. 6A, 6B), the thermoplastic member 620 may include an inner portion 621 positioned on an inner surface of the frame structure 600, an outer portion 622 having at least a portion seen from the outside of the frame structure 600, and a connection portion 623 connecting the inner portion 621 and the outer portion 622. However, the structure of the thermoplastic member 620 is not limited to the above-described embodiment, and in another embodiment (for example, see FIG. 6C), the thermoplastic member 620 may be formed in a flat plate shape or a rectangular pillar shape penetrating through at least one opening 601 formed on one side surface of the frame structure 600.

The sensor 630 according to an embodiment may be attached to an inner surface (for example, the inner portion 621) of the thermoplastic member 620 to measure a degree of deformation of the thermoplastic member 620 caused by a user's input. The sensor 630 may be electrically connected with a processor (for example, the processor 440 of FIG. 4A) mounted inside the electronic device, and the processor may detect the user input based on a degree of deformation measured by the sensor 630.

In an embodiment (for example, see FIG. 6A), when a user touches at least a portion (for example, the outer portion 622) of the thermoplastic member 620 that is seen from the outside of the frame structure 600, the thermoplastic member 620 may be deformed by the user's touch and a variable resistance value of the sensor 630 may increase. When it is determined that the variable resistance value of the sensor 630 attached to a certain region of the thermoplastic member 620 is greater than or equal to a designated threshold, the processor may detect that a user's touch input is inputted to a certain region of the thermoplastic member 620. The touch input in the disclosure may refer to an input of a user pressing the key input device (for example, the thermoplastic member) by a force, and hereinafter, may be used as the same meaning.

In another embodiment (for example, see FIG. 6B), the sensor 630 attached to the inner surface of the thermoplastic member 620 may detect a user's swipe input on the thermoplastic member 620. The swipe input in the disclosure may refer to an input of rubbing the key input device (for example, the thermoplastic member) from a first direction (for example, an upper end or a left side) to a second direction (for example, a lower end or a right side), or inversely, from the second direction to the first direction, and hereinafter, may be used as the same meaning. When the user swipes on the thermoplastic member 620 seen from the outside of the frame structure 600, the variable resistance value of the sensor 630 attached to the thermoplastic member 620 on which the user swipes may increase. In an embodiment, when the user swipes on the thermoplastic member 620 from the first direction (for example, an upper end direction of FIG. 6B) to the second direction (for example, a lower end direction of FIG. 6B), the variable resistance values of the sensor 630 from the first direction to the second direction may increase sequentially during a designated time. In another embodiment (not shown), when the user swipes on a certain region of the thermoplastic member 620 in a display direction, the variable resistance value of the sensor 630 may be gradually reduced during a designated time, and the swipe input may be changed to a touch input on the display. When it is determined that a change in the variable resistance value of the sensor 630 is greater than or equal to a designate threshold, the processor may detect that a user's swipe input is inputted to the thermoplastic member 620. According to an embodiment (for example, FIG. 6B), a height h2 of the outer portion 622 of the thermoplastic member 620 may be the same as a height h1 of the inner portion 621, such that the user's swipe input can be detected. However, the structure of the thermoplastic member 620 is not limited to the above-described embodiments, and in another embodiment (not shown), the height h2 of the outer portion 622 may be higher than the height h1 of the inner portion 621.

In still another embodiment (for example, see FIG. 6C), the sensor 630 attached to the inner surface of the thermoplastic member 620 may detect a user's squeeze input on the thermoplastic member 620. The squeeze input in the disclosure refers to an input of the user pressing at least a certain region of the key input device (for example, the thermoplastic member) by a force, and may refer to an input of applying a force or a pressure to a larger region than in the case of the above-described touch input, and hereinafter, may be used as the same meaning. When the user squeezes a certain region of the thermoplastic member 620, the variable resistance value of the sensor 630 attached to the certain region may increase. The processor may compare the increased variable resistance value and a designated threshold, and, when the variable resistance value of the certain region of the thermoplastic member 620 is greater than or equal to the designated threshold, the processor may detect that a squeeze input is inputted to the thermoplastic member 620.

The processor may perform various functions (for example, a volume control, power on/off, etc.) set for a corresponding region, according to a region of the thermoplastic member 620 to which a touch input, a swipe input, and/or a squeeze input of the user is inputted.

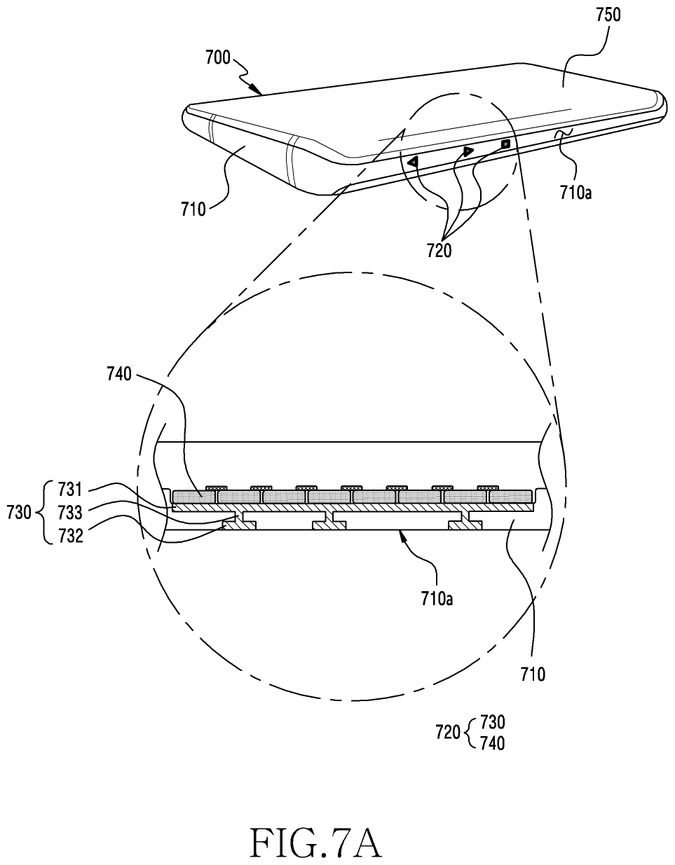

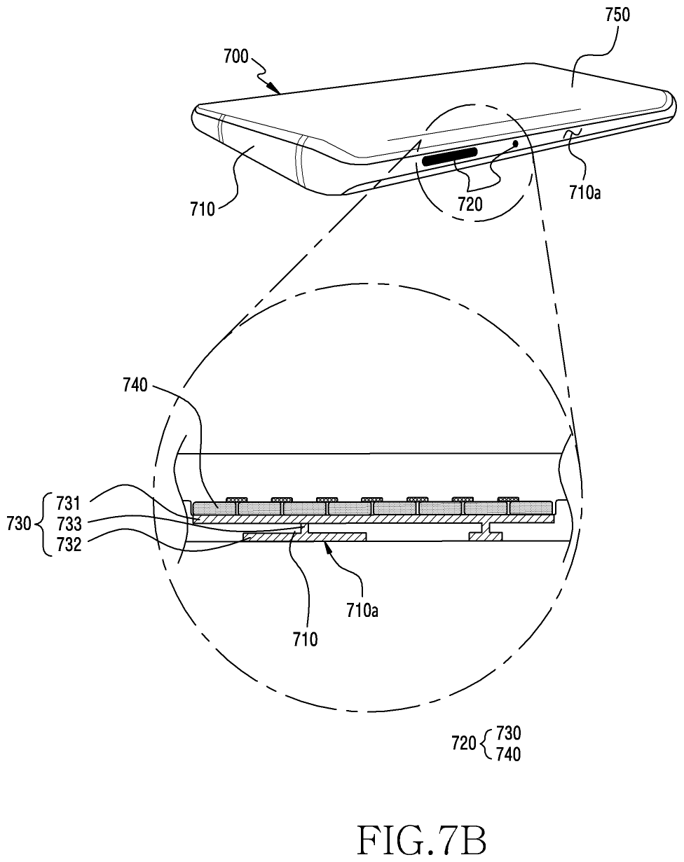

FIG. 7A is a view illustrating a key input device positioned on one side surface of an electronic device according to an embodiment, and FIG. 7B is a view illustrating a key input device positioned on one side surface of the electronic device according to another embodiment.

Referring to FIGS. 7A and 7B, the electronic device 700 (for example, the electronic device 400 of FIGS. 4A, 4B) according to an embodiment may include a frame structure 710 (for example, the frame structure 500 of FIG. 5) forming a side surface of the electronic device 700, a key input device 720 (for example, the key input device 510 of FIG. 5B), a display 750 (for example, the display 430 of FIGS. 4A, 4B). At least one of the components of the electronic device 700 may be the same as or similar to at least one of the components of the electronic device of FIGS. 5A, 5B, 5C, 5D, 5E, and a redundant explanation thereof is omitted.

The key input device 720 (for example, the key input device 510 of FIGS. 5A, 5B) according to an embodiment may be positioned on one side surface 710a of the frame structure 70, and may include an thermoplastic member 730 (for example, the thermoplastic member 520 of FIGS. 5B, 5C, 5D) and a sensor 740 (for example, the sensor 530 of FIG. 5).

According to an embodiment, at least one opening 701 may be formed on one side surface 710a of the frame structure 710, and the thermoplastic member 730 may penetrate through at least a region of the opening 701 and may be positioned on an inner surface of the frame structure 710.

In an embodiment, the thermoplastic member 730 may include an inner portion 731 (for example, the inner portion 521 of FIG. 5B) positioned on an inner surface of the frame structure 710, an outer portion 732 (for example, the outer portion 522 of FIG. 5B) seen from the outside of the frame structure 710 through the opening 701, and a connection portion 733 (for example, the connection portion 523 of FIG. 5B) connecting the inner portion 731 and the outer portion 732. The sensor 740 according to an embodiment may be attached to the inner portion 731 of the thermoplastic member 730 to be positioned on an inner surface of the frame structure 710, and may detect a deformation of the thermoplastic member 730 caused by a user's input.

In an embodiment (for example, see FIGS. 7A, 7B), the thermoplastic member 730 may be formed in such a structure that at least one outer portion 732 positioned on a region corresponding to the at least one opening 701 is attached to one inner portion 731 formed in a flat plate shape through a plurality of connection portions 733. However, the structure of the thermoplastic member 730 is not limited to the above-described embodiment, and in another embodiment (not shown), the thermoplastic member 730 may form a structure in which one set of the outer portion 732, the connection portion 733, and the inner portion 731 is disposed in every region corresponding to the at least one opening 701.

The user may recognize a position where the key input device 720 is mounted, through the outer portion 732 exposed to the outside of the frame structure 710 through the at least one opening 701 formed on one side surface 710a of the frame structure 710. A shape of the outer portion 732 exposed to the outside of the frame structure 710 may vary according to a shape of the opening 701 formed on one side surface 710a of the frame structure 710. The thermoplastic member 730 may be formed on a region adjacent to the at least one opening 701 of the frame structure 710 by being insert-injected, and as a result, the shape of the outer portion 732 seen from the outside of the frame structure 710 may correspond to the shape of the opening 701. In an embodiment (for example, 7A), when the opening 701 is formed in a triangular shape or a rectangular shape, the outer portion 732 may be formed in a triangular shape or a rectangular shape. In another embodiment (for example, FIG. 7B), when the opening 701 is formed in a slot shape or a circular shape, the outer portion 732 may be formed in a rectangular shape having rounded corners, or a circular shape.

The electronic device 700 according to an embodiment may have the key input device 720 formed in various shapes by having the opening 701 formed in various shapes according to a function (for example, a volume control, power on/off) set in the key input device 720 positioned on a certain region. In an embodiment, the outer portion 732 of the key input device 720 that is set to perform a volume control of the electronic device 700 in response to a user's input may be formed in a triangular shape. In another embodiment, the outer portion 732 of the key input device 720 that is set to perform a voice assistance function of the electronic device 700 in response to a user's input may be formed in a rectangular shape.

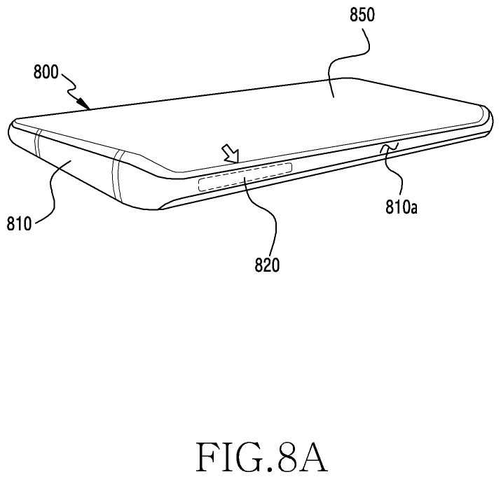

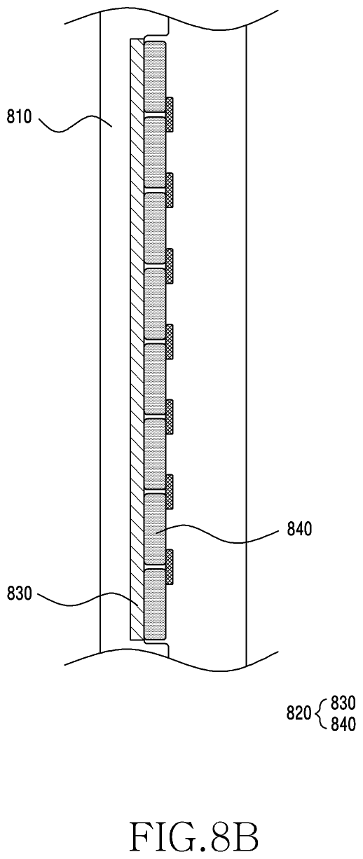

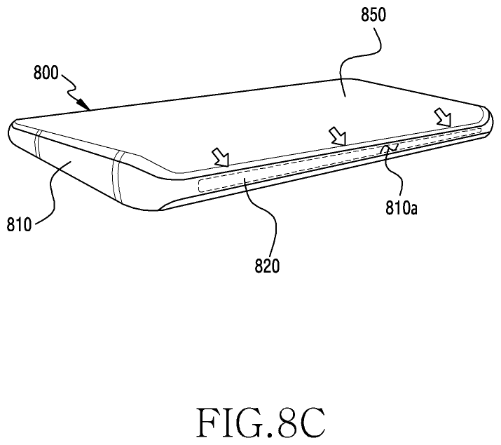

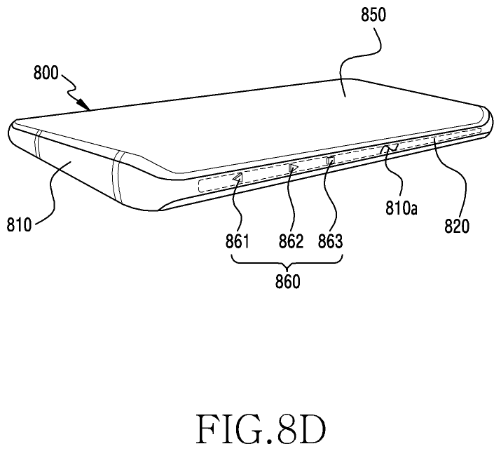

FIG. 8A is a perspective view illustrating an electronic device according to an embodiment, FIG. 8B is a view illustrating an thermoplastic member and a sensor which are mounted in the electronic device of FIG. 8A, FIG. 8C is a perspective view illustrating an electronic device according to another embodiment, and FIG. 8D is a perspective view illustrating an electronic device according to still another embodiment.

Referring to FIGS. 8A, 8B, 8C, and 8D, the electronic device 800 according to an embodiment may include a frame structure 810 (for example, the frame structure 500 of FIG. 5A) forming a side surface of the electronic device 800, a key input device 820, and a display 850 (for example, the display 430 of FIGS. 4A, 4B). At least one of the components of the electronic device 800 may be the same as or similar to at least one of the components of the electronic device 700 of FIGS. 7A, 7B, and a redundant explanation thereof is omitted.

The key input device 820 according to an embodiment may include an thermoplastic member 830 (for example, the thermoplastic member 620 of FIG. 6C) positioned on an inner surface of the frame structure 810 and having a plate shape, and a sensor 840 (for example, the sensor 630 of FIG. 6C) attached to an inner surface of the thermoplastic member 830. In an embodiment, the thermoplastic member 830 may be deformed (for example, deformationed) by a user's input (for example, a touch input, a swipe input, a squeeze input) on the frame structure 810, and the sensor 840 attached to the inner surface of the thermoplastic member 830 may detect a degree of deformation (for example, a degree of deformation) of the thermoplastic member 830.

The sensor 840 according to an embodiment may be electrically connected with a processor (for example, the processor 440 of FIG. 4A), and the processor may detect whether a user's input (for example, a touch input, a swipe input, a squeeze input) is inputted, based on an output value of the sensor 840.

In an embodiment (for example, see FIG. 8A), the key input device 820 may be disposed only on a certain region of one side surface 810a of the frame structure 810, such that the electronic device 800 can detect a user's touch input. In another embodiment (for example, see FIG. 8C) the key input device 820 may be disposed on an entire region of one side surface 810a of the frame structure 810, such that the electronic device 800 can detect not only a user's touch input but also a swipe input, a squeeze input.

A separate opening (for example, the opening 701 of FIGS. 7A, 7B) may not be formed on one side surface of the frame structure 810 according to an embodiment, and accordingly, the key input device 820 may not be exposed to the outside of the frame structure 810, unlike the above-described key input device (for example, the key input device 720 of FIGS. 7A, 7B). In the above-described case, the user may not recognize a position where the key input device 820 is mounted. The electronic device 800 according to an embodiment (for example, see FIG. 8C) may display a graphic user interface (GUI) (for example, an arrow mark) indicating the position where the key input device 820 is mounted on the display 850 to inform the user of the position where the key input device 820 is mounted. The electronic device 800 according to another embodiment (for example, see FIG. 8D) may include a display portion 860 formed on one side surface of the frame structure 810, and may inform the user of the position where the key input device 820 is mounted through the display portion 860. In an embodiment, the display portion 860 may be formed on one side surface of the frame structure 810 in an embossed or engraved shape, or may be formed in various shapes (for example, a triangular shape, a rectangular shape, etc.). According to an embodiment, the display portion 860 may include a first display portion 861, a second display portion 862, or a third display portion 863. When a user applies an input to the display portion 860, the processor may detect the user's input through the key input device 820 mounted in the frame structure 810. For example, when the user applies an input to the first display portion 861, the processor may detect the user's input on a region corresponding to the first display portion 861, and may perform a first function (for example, a volume control) of the electronic device. In another example, when the user applies an input to the third display portion 863, the processor may detect the user's input on a region corresponding to the third display portion 863, and may perform a second function (for example, a voice assistance function) of the electronic device.

An electronic device (for example, the electronic device 300 of FIG. 3 or the electronic device 400 of FIG. 4) according to an embodiment of the disclosure may include: a frame structure (for example, the frame structure 410 of FIG. 4) forming a side surface (for example, 210C of FIG. 2A) of the electronic device; at least one opening (for example, the opening 501 of FIG. 5B) formed on a certain region of the side surface; an thermoplastic member (for example, the thermoplastic member 520 of FIG. 5B) positioned on a region of an inner surface of the frame structure adjacent to the opening to fill at least a portion of the opening; and a sensor (for example, the sensor 530 of FIG. 5B) attached to an inner surface of the thermoplastic member and electrically connected with a processor (for example, the processor 440 of FIG. 4A).

According to an embodiment, the thermoplastic member may be formed with a material having a lower rigidity than the frame structure.

According to an embodiment, at least a certain region of the thermoplastic member may be seen from an outside of the electronic device through the opening.

According to an embodiment, the sensor may include at least one of a pressure sensor and a strain gauge.

According to an embodiment, the thermoplastic member may include: an inner portion (for example, the inner portion 521 of FIG. 5B) of a plate shape mounted on an inner surface of the frame structure; an outer portion (for example, the outer portion 522) filling at least a portion of the opening and seen from an outside of the electronic device; and a connection portion (for example, the connection portion 523 of FIG. 5B) connecting the inner portion and the outer portion.

According to an embodiment, the outer portion may be formed to completely fill the opening.

According to an embodiment, at least a portion of the outer portion may be formed to protrude to an outside of the frame structure.

According to an embodiment, a length of the outer portion may be shorter than a length of the inner portion.

According to an embodiment, a length of the inner portion and a length of the outer portion may be the same as each other.

According to an embodiment, the thermoplastic member may be formed with a transparent material.

According to an embodiment, the electronic device may further include at least one LED module (for example, the LED module 540 of FIG. 5E) disposed on a position of the inner surface of the frame structure adjacent to the sensor.

According to an embodiment, the electronic device may further include: a display (for example, the display 430 of FIG. 4B) mounted on or connected to the frame structure to be seen from the outside through a front surface of the electronic device; and a rear surface plate (for example, the rear surface plate 411 of FIG. 4B) mounted on or connected to the frame structure to form a rear surface of the electronic device.

According to an embodiment, the frame structure may further include at least one slit (for example, the slit 502 of FIG. 5E) formed on a region adjacent to the sensor.

According to an embodiment, the processor may be configured to detect a user's input on the sensor, based on an output value of the sensor.

According to an embodiment, the user input may include at least one of a touch input, a swipe input, and a squeeze input.

According to another embodiment of the disclosure, an electronic device (for example, the electronic device 800 of FIG. 8A) may include: a frame structure (for example, the frame structure 810 of FIG. 8A) forming a side surface of the electronic device; an thermoplastic member (for example, the thermoplastic member 830 of FIG. 8B) positioned on at least a certain region of an inner surface of the frame structure; and a sensor (for example, the sensor 840 of FIG. 8B) attached to an inner surface of the thermoplastic member and electrically connected with the processor.

According to an embodiment, at least one surface of the thermoplastic member may be formed in a plate shape.

According to an embodiment, the thermoplastic member may be formed with a material having a lower rigidity than the frame structure.

According to an embodiment, the sensor may include at least one of a pressure sensor and a strain gauge.

According to an embodiment, the processor may be configured to detect a user's input on the sensor, based on an output value of the sensor.

The electronic device according to certain embodiments can enhance a detection rate of a user input by maintaining flatness of a surface to which the sensor is attached through the thermoplastic member penetrating through a side surface of the housing, and reducing influence of a change in temperature of the electronic device on a measurement value of the sensor.

In addition, the electronic device according to certain embodiments can inform a user of a position where the sensor is mounted, without separate additional processing.

According to certain embodiments, an electronic device comprises a frame forming a side surface of the electronic device; at least one opening formed on a certain region of the side surface; a thermoplastic member positioned on a region of an inner surface of the frame structure adjacent to the opening to fill at least a portion of the opening; and a sensor attached to an inner surface of the thermoplastic member and electrically connected with a processor.

According to certain embodiments, the thermoplastic member has a lower rigidity than the frame.

According to certain embodiments, at least a certain region of the thermoplastic member is visible from an outside of the electronic device through the opening.

According to certain embodiments, the sensor comprises at least one of a pressure sensor and a strain gauge.

According to certain embodiments, the thermoplastic member comprises an inner portion of a plate shape mounted on an inner surface of the frame structure; an outer portion filling at least a portion of the opening and seen from an outside of the electronic device; and a connection portion connecting the inner portion and the outer portion.

According to certain embodiments, the outer portion completely fills the opening.

According to certain embodiments, at least a portion of the outer portion protrudes to an outside of the frame.

According to certain embodiments, the outer portion is shorter than the inner portion.

According to certain embodiments, a length of the inner portion and a length of the outer portion are the substantially equal.

According to certain embodiments, the thermoplastic member comprises a transparent material.

According to certain embodiments, the electronic device further comprises at least one LED module disposed on a position of the inner surface of the frame adjacent to the sensor.

According to certain embodiments, the electronic device further comprises: a display mounted on or connected to the frame structure visible from the outside through a front surface of the electronic device; and a rear surface plate mounted on or connected to the frame structure to form a rear surface of the electronic device.

According to certain embodiments, the frame further comprises at least one slit formed on a region adjacent to the sensor.

According to certain embodiments, the processor is configured to detect a user's input on the sensor, based on an output value of the sensor.

According to certain embodiments, the user input comprises at least one of a touch input, a swipe input, and a squeeze input.

According to certain embodiments, an electronic device comprises a frame forming a side surface of the electronic device; a thermoplastic member positioned on at least a certain region of an inner surface of the frame structure; and a sensor attached to an inner surface of the thermoplastic member and electrically connected with the processor.

According to certain embodiments, at least one surface of the thermoplastic member is planar.

According to certain embodiments, the thermoplastic member has a lower rigidity than the frame.

According to certain embodiments, the sensor comprises at least one of a pressure sensor and a strain gauge.

According to certain embodiments, the processor is configured to detect a user's input on the sensor, based on an output value of the sensor.

In the above-described specific embodiments of the disclosure, elements included in the disclosure are expressed in singular or plural forms according to specific embodiments. However, singular or plural forms are appropriately selected according to suggested situations for convenience of explanation, and the disclosure is not limited to a single element or plural elements. An element which is expressed in a plural form may be configured in a singular form or an element which is expressed in a singular form may be configured in plural number.

While the disclosure has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An electronic device comprising:
a frame forming a side surface of the electronic device;
at least one opening formed on a certain region of the side surface;
a thermoplastic member positioned on a region of an inner surface of the frame adjacent to the opening to fill at least a portion of the opening; and
a sensor attached to an inner surface of the thermoplastic member and electrically connected with a processor.

2. The electronic device of claim 1, wherein the thermoplastic member has a lower rigidity than the frame.

3. The electronic device of claim 1, wherein at least a certain region of the thermoplastic member is visible from outside of the electronic device through the opening.

4. The electronic device of claim 1, wherein the sensor comprises at least one of a pressure sensor and a strain gauge.

5. The electronic device of claim 1, wherein the thermoplastic member comprises:
an inner portion of a plate shape mounted on the inner surface of the frame;
an outer portion filling at least a portion of the opening and seen from outside of the electronic device; and
a connection portion connecting the inner portion and the outer portion.

6. The electronic device of claim 5, wherein the outer portion completely fills the opening.

7. The electronic device of claim 5, wherein at least a portion of the outer portion protrudes to the outside of the frame.

8. The electronic device of claim 5, wherein the outer portion is shorter than the inner portion.

9. The electronic device of claim 5, wherein a length of the inner portion and a length of the outer portion are substantially equal.

10. The electronic device of claim 1, wherein the thermoplastic member comprises a transparent material.

11. The electronic device of claim 10, further comprising at least one LED module disposed on a position of the inner surface of the frame adjacent to the sensor.

12. The electronic device of claim 1, further comprising:
a display mounted on or connected to the frame visible from the outside through a front surface of the electronic device; and
a rear surface plate mounted on or connected to the frame to form a rear surface of the electronic device.

13. The electronic device of claim 1, wherein the frame further comprises at least one slit formed on a region adjacent to the sensor.

14. The electronic device of claim 1, wherein the processor is configured to detect a user's input on the sensor, based on an output value of the sensor.

15. The electronic device of claim 14, wherein the user input comprises at least one of a touch input, a swipe input, and a squeeze input.

16. An electronic device comprising:
a frame forming a side surface of the electronic device;
a thermoplastic member positioned on at least a certain region of an inner surface of the frame; and
a sensor attached to an inner surface of the thermoplastic member and electrically connected with a processor.

17. The electronic device of claim 16, wherein at least one surface of the thermoplastic member is planar.

18. The electronic device of claim 16, wherein the thermoplastic member has a lower rigidity than the frame.

19. The electronic device of claim 16, wherein the sensor comprises at least one of a pressure sensor and a strain gauge.

20. The electronic device of claim 19, wherein the processor is configured to detect a user's input on the sensor, based on an output value of the sensor.
